(19) United States
(12) Patent Application Publication
(10) Pub. No.: US 2024/0314625 A1
(43) Pub. Date: Sep. 19, 2024

(54) METHOD AND NETWORK NODES FOR HANDLING BUFFER STATUS REPORT (BSR) FORMATS

(71) Applicant: Telefonaktiebolaget LM Ericsson (publ), Stockholm (SE)

(72) Inventors: Ajmal Muhammad, Sollentuna (SE); Jose Luis Pradas, Stockholm (SE)

(21) Appl. No.: 18/550,184

(22) PCT Filed: Jan. 14, 2022
(86) PCT No.: PCT/SE2022/050043

§ 371 Date: Sep. 12, 2023

Related U.S. Application Data
(60) Provisional application No. 63/137,173, filed on Jan. 14, 2021.

(51) Int. Cl. H04W 28/02

(52) U.S. Cl. CPC H04W 28/0278

(57) ABSTRACT

The present disclosure provides, for example, a method performed by a first network node for handling BSRs in a communications system. The method includes determining a format for a BSR, wherein the determined format indicates that the BSR includes a LCG range; creating the BSR with the determined format; and providing the created BSR with the determined format to a second network node.

### TECHNICAL FIELD

Embodiments herein relate generally to a first network node, a second network node and methods performed by the first network node and the second network node. Furthermore, a computer program and a carrier are also provided herein. More particularly the embodiments herein relate to handling Buffer Status Reports (BSR), or relate to handling BSR formats.

### BACKGROUND

In the Third Generation Partnership Project (3GPP) Release 16 time frame, the potential solutions for efficient operation of integrated access and wireless access backhaul in New Radio (NR) Integrated Access Backhaul (IAB) are being studied in IAB Study Item/Work Item (SI/WI). In the studied scenarios, an IAB network comprises a number of IAB nodes and user equipments (UE) served by these IAB nodes. The data routing is performed across IAB nodes. The 3GPP Release 15 functionalities are assumed as a baseline for any potential enhancement.

In the following, the IAB system basic structure and the relevant 3GPP agreements are briefly described.

### Introduction of IAB System Structure.

In Release 16, the IAB has been approved as a study item. IAB strives to reuse existing functions and interfaces defined for access. In particular, Mobile-Termination (MT), gNodeB-Distributed Unit (gNB-DU), gNB-Centralized Unit (gNB-CU), User Plane Function (UPF), Access and Mobility Management Function (AMF) and Session Management Function (SMF) as well as the corresponding interfaces New Radio (NR) Uu, between MT and gNB, F1, NG, X2 and N4 are used as baseline for the IAB architectures. Modifications or enhancements to these functions and interfaces for the support of IAB will be explained in the context of the architecture discussion. Additional functionality such as multi-hop forwarding is included in the architecture discussion as it is necessary for the understanding of IAB operation and since certain aspects may require standardization.

The MT function has been defined as a component of the Mobile Equipment, i.e., UE. In the context of this study, MT is referred to as a function residing on an IAB-node that terminates the radio interface layers of the backhaul Uu interface toward the IAB-donor or other IAB-nodes.

FIG. 1 shows a reference diagram for IAB in standalone mode, which comprises one IAB-donor 105 and multiple IAB-nodes 103. The IAB-donor 105 is treated as a single logical node that comprises a set of functions such as gNB-DU, gNB-CU-CP, gNB-CU-UP and potentially other functions. CP is short for Control Plane and UP is short for User Plane. In a deployment, the IAB-donor 105 may be split according to these functions, which can all be either collocated or non-collocated as allowed by 3GPP NG-Radio access Network (RAN) architecture. IAB-related aspects may arise when such split is exercised. Also, some of the functions presently associated with the IAB-donor 105 may eventually be moved outside of the donor in case it becomes evident that they do not perform IAB-specific tasks.

The IAB-node 103 is defined in 3GPP TR 38.874 V16.0.0 (2018-12) as a “RAN node that supports wireless access to UEs and wirelessly backhauls the access traffic”, and the IAB-donor 105 as a “RAN node which provides UE's interface to core network and wireless backhauling functionality to IAB-nodes.”

The IAB node 103 may be referred to as an IAB child or a child IAB node, and the IAB donor 105 may be referred to as a parent node or a parent IAB node. FIG. 1 shows a UE 101 adapted to communicate with the IAB node 103 e.g. via a wireless access link 102. FIG. 1 shows an example with three UEs 101 each connected to a respective IAB node 103, but any other suitable n number of UEs 101 are applicable where n is a positive integer. In FIG. 1 there are also IAB nodes 103 which are not connected to any UE 101. In addition to be adapted to be connected to the UE 101, the IAB node 103 may be adapted to be connected to another IAB node 103, i.e., two IAB nodes 103 may be adapted to be connected to each other, e.g., via a wireless backhaul link 104.

FIG. 1 shows an example with five IAB nodes 103, but any other suitable m number of IAB nodes 103 are applicable where m is a positive integer.

The wireless backhaul link 104 is between IAB nodes 103 and between IAB nodes 103 and an IAB donor 105, e.g., between a DU 108 comprised in the IAB donor 105. The wireless access link 102 is between the UE 101 and the IAB node 103.

FIG. 1 shows that the DU 108 may be adapted to be connected to one or more IAB nodes 103.

The IAB donor 105 may comprise one or more DUs 108, a CU-CP, a CU-UP and optionally other functions. There may be a wireline IP connection 109 between the DU 108 and the CU-CP, a CU-UP and optionally other functions.

The IAB donor 105 may be adapted to be connected to a Core Network (CN) 110.

3GPP has identified two different methods to map the different Data Radio Bearers (DRB) of each UE to the Backhaul (BH) Radio Link Control (RLC) Channels.

Option 1. One-to-one mapping between UE DRB and BH RLC-channel. In this option, each UE DRB is mapped onto a separate BH RLC-channel. Further, each BH RLC-channel is mapped onto a separate BH RLC-channel on the next hop. The number of established BH RLC-channels is equal to the number of established UE DRBs. Thus, one-to-one mapping needs to enhance the number of RLC channels. FIG. 2 shows an example of one-to-one mapping between UE DRB and BH RLC-Channel.

Option 2. Many-to-one mapping between UE DRBs and BH RLC-channel. For the many-to-one mapping, several UE DRBs are multiplexed onto a single BH RLC-channel based on specific parameters such as bearer quality of service (QOS) profile. Other information such as hop-count could also be configured. The IAB-node 103 may multiplex UE DRBs into a single BH RLC-channel even if they belong to different UEs. Furthermore, a packet from one BH RLC-channel may be mapped onto a different BH RLC-channel on the next hop. All traffic mapped to a single BH RLC-channel receive the same QoS treatment on the air interface. Furthermore, for many-to-one mapping, existing number of RLC channels might be sufficient. FIG. 3 shows an example of many-to-one mapping between UE DRBs and BH RLC-channel.

For the first option, one-to-one, the number of Logical Channel Identification (LCID) for the BH RLC channels may need to be increased as currently 3GPP only supports a very limited number of LCIDs. If the LCID range is extended, the Logical Channel Groups (LCG) may also need to be extended. This latter extension affects the Buffer Status Report (BSR) formats.

BSR reports are used to inform the network about the buffer status of the different LCG that the UE 101 has been configured with. A Logical Channel Group is made of one or more Logical Channels. In current Release 15 specifications, the network may configure up to 8 LCGs for a UE.

There are currently 3 different types of BSR formats:
Short BSR: this format is used to report the buffer status of the only LCG which have data available for transmission.
Long BSR: this format is used to report all LCGs which have data available for transmission.
Short Truncated BSR: this format is used to report the buffer status of the LCG with the highest priority logical channel(s) with data available for transmission.
Long Truncated BSR: this format is used to report the LCG(s) with the logical channels having data available for transmission following a decreasing order of the highest priority logical channel (with or without data available for transmission) in each of these LCG(s), and in case of equal priority, in increasing order of LCG ID. With this format, the UE 101 reports only as many LCG as possible, but not all.

FIG. 4 shows an example of a short BSR and Short Truncated BSR medium access control (MAC) control element (CE).

FIG. 5 shows an example of a Long BSR and Long Truncated BSR MAC CE.

New BSR formats are needed when the LCG range is extended; however, extending the BSR emulating the Release 15 format is not a good option.

The current BSR formats are designed to serve a single UE. However, in an IAB network, the MT part of an IAB node will forward data to parent DU for many UEs with different services. Up to 8 LCGs for BSR as in Release 15 is not enough to report buffer status for an uplink backhaul link configured with many logical channels. Hence, the existing BSR formats do not fit for the reporting of an MT. Besides, a straightforward extension of current BSR formats, i.e., combining BSR formats, one for each UE 101 served by the IAB node, is not an optimal approach due to the large amount of LCG bitmap overhead that the BSR may inflict.

Therefore, there is a need to at least mitigate or solve this issue.

### SUMMARY

An objective of embodiments herein is therefore to obviate at least one of the above disadvantages and to improve buffer status reporting, to improve reporting in a communications system, or to improve buffer information handling, etc.

According to a first aspect, the object is achieved by a method performed by a first network node for handling BSRs in a communications system. The first network node determines a format for a BSR, wherein the determined format indicates that the BSR comprises a LCG range, and the first network node creates the BSR with the determined format. The first network node provides, or forwards, the created BSR with the determined format to a second network node.

According to another aspect, the object is achieved by a method performed by a second network node for handling BSR in a communications system. The second network node receives a BSR, from a first network node, with a determined format, wherein the determined format indicates that the BSR comprises a LCG range.

According to yet another aspect, the object is achieved by a first network node that is adapted to determine a format for a BSR, wherein the determined format indicates that the BSR comprises a LCG range. The first network node is further adapted to create the BSR with the determined format; and to provide, or forward, the created BSR with the determined format to a second network node.

According to still another aspect, the object is achieved by a second network node adapted to receive a BSR, from a first network node, with a determined format, wherein the determined format indicates that the BSR comprises a LCG range.

Embodiments herein afford one or more advantages, of which a non-exhaustive example follows:

The embodiments herein provide a set of formats which enables an efficient buffer status report even when there are many LCGs, reducing the overhead by indicating the LCG range.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail by way of example only in the following detailed description by reference to the appended drawings illustrating the embodiments and in which:

FIG. 1 is a schematic block diagram illustrating an example of an IAB-architecture.

FIG. 2 is a schematic block diagram illustrating an example of a one-to-one mapping between UE DRB and BH RLC-Channel.

FIG. 3 is a schematic block diagram illustrating an example of many-to-one mapping between UE DRBs and BH RLC-channel.

FIG. 4 is a schematic block diagram illustrating an example of a Short BSR and Short Truncated BSR MAC CE.

FIG. 5 is a schematic block diagram illustrating an example of a Long BSR and Long Truncated BSR MAC CE.

FIG. 6 is a schematic drawing illustrating a communications system.

FIG. 7a is a signalling diagram illustrating a method.

FIG. 7b is a signalling diagram depicting a method performed by a first network node according to embodiments herein;

FIG. 7c is a schematic flowchart depicting a method performed by a second network node according to embodiments herein;

FIG. 8 is a schematic block diagram illustrating an example of a BSR format.

FIG. 9 is a schematic block diagram illustrating an example of a BSR format.

FIG. 10 is a schematic block diagram illustrating an example of a BSR format.

FIG. 11 is a schematic block diagram illustrating an example of a BSR format.

FIG. 12 is a schematic block diagram illustrating an example of a BSR format.

FIG. 13 is a schematic block diagram illustrating an example of a BSR format.

FIG. 14 is a schematic block diagram illustrating an example of a BSR comprising individual buffer status report and aggregated buffer status report for rest LCGs.

FIG. 15 is a schematic block diagram illustrating an example of a BSR comprising individual buffer status report and aggregated buffer status report and the LCG range of the remaining LCGs is indicated as well.

FIG. 16a is a schematic drawing illustrating an example of a network node.

FIG. 16b is a schematic drawing illustrating an example of a network node.

FIG. 17a is a schematic drawing illustrating an example of a UE.

FIG. 17b is a schematic drawing illustrating an example of a UE.

FIG. 18 is a schematic block diagram illustrating a telecommunication network connected via an intermediate network to a host computer.

FIG. 19 is a schematic block diagram of a host computer communicating via a base station with a user equipment over a partially wireless connection.

FIG. 20 is a flowchart depicting embodiments of a method in a communications system including a host computer, a base station and a user equipment.

FIG. 21 is a flowchart depicting embodiments of a method in a communications system including a host computer, a base station and a user equipment.

FIG. 22 is a flowchart depicting embodiments of a method in a communications system including a host computer, a base station and a user equipment.

FIG. 23 is a flowchart depicting embodiments of a method in a communications system including a host computer, a base station and a user equipment.

The drawings are not necessarily in scale and the dimensions of certain features may have been exaggerated for the sake of clarity. Emphasis is instead placed upon illustrating the principle of the embodiments herein.

### DETAILED DESCRIPTION

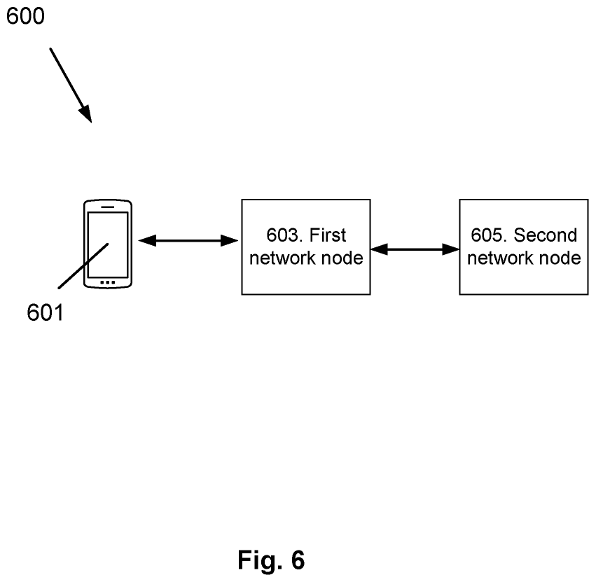

FIG. 6 depicts a non-limiting example of a communications system 600, which may be a wireless communications network, sometimes also referred to as a wireless communications system, cellular radio system, or cellular network, in which embodiments herein may be implemented. The communications system 600 may typically be a 5G system, 5G network, NR-U or Next Gen System or network, LAA, MulteFire, a 4G system, a 3G system, a 2G system, a further generation system or any other suitable system. The communications system 600 may alternatively be a younger system than a 5G system. The communications system 600 may support other technologies such as, for example, Long-Term Evolution (LTE), LTE-Advanced/LTE-Advanced Pro, e.g., LTE Frequency Division Duplex (FDD), LTE Time Division Duplex (TDD), LTE Half-Duplex Frequency Division Duplex (HD-FDD), LTE operating in an unlicensed band, narrowband-internet of things (NB-IoT). Thus, although terminology from 5G/NR and LTE may be used in this disclosure to exemplify embodiments herein, this should not be seen as limiting the scope of the embodiments herein to only the aforementioned systems. The embodiments herein apply to any previous, current, or future system.

The communications system 600 comprises a plurality of network nodes, whereof a first network node 603 and a second network node 605, also referred to herein as a network node 603, 605, are depicted in the non-limiting example of FIG. 6. Any of the first network node 603 and the second network node 605 may be a radio network node, such as a radio base station, or any other network node with similar features capable of serving a user equipment, such as a wireless device or a machine type communication device, in the communications system 600. In some embodiments, the first network node 603 is an eNB and the second network node 605 is a gNB. In other embodiments, the first network node 603 is a first gNB, and the second network node 605 is a second gNB. In yet other embodiments, the first network node 603 may be a master eNB (MeNB) and the second network node 605 may be a gNB. In some examples, any of the first network node 603, and the second network node 605 may be co-localized or be part of the same network node. In embodiments herein, the first network node 603 may be referred to as a source node or source network node, whereas the second network node 605 may be referred to as a target node or target network node. The first network node may be referred to as a child node and the second network node may be referred to as a parent node. The first network node 603 may be referred to as an IAB node and the second network node 605 may be referred to as an IAB donor.

The communications system 600 covers a geographical area which may be divided into cell areas, wherein each cell area may be served by a network node, although, one network node may serve one or several cells. In the example in FIG. 6, the communications system 600 comprises a first cell and a second cell (not shown). In FIG. 6, first network node 603 serves the first cell, and the second network node 605 serves the second cell. Any of the first network node 603, and the second network node 605 may be of different classes, such as, e.g., base station (BS), macro BS, home BS or pico BS, based on transmission power and thereby also cell size. Any of the first network node 603 and the second network node 605 may be directly connected to one or more core networks, which are not depicted in FIG. 6 to simplify the figure. In some examples, any of the first network node 603, and the second network node 605 may be a distributed node, such as a virtual node in the cloud, and it may perform its functions entirely on the cloud, or partially, in collaboration with a radio network node. In embodiments herein, the first cell may be referred to as a source cell, whereas the second cell may be referred to as a target cell.

A plurality UEs may be located in the communications system 600, whereof a UE 601, which may also be referred to as a device, is depicted in the non-limiting example of FIG. 6. The UE 601, e.g., an LTE UE or a 5G/NR UE, may be a wireless communication device which may also be known as e.g., a wireless device, a mobile terminal, a wireless terminal and/or a mobile station, a mobile telephone, a cellular telephone, or a laptop with wireless capability, just to mention some further examples. The UE 601 may be a device by which a subscriber may access services offered by an operator's network and services outside operator's network to which the operator's radio access network and core network provide access, e.g., access to the Internet. The UE 601 may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, Machine to Machine (M2M) device, Internet of Things (IoT) device, terminal device, communication device or any type of consumer electronic, for instance but not limited to television, radio, lighting arrangements, tablet computer, laptop or Personal Computer (PC). The UE 601 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system.

The first network node 603 may be configured to communicate in the communications system 600 with the UE 601 over a first communication link, e.g., a radio link. The second network node 605 may be configured to communicate in the communications system 600 with the UE 601 over a second communication link, e.g., a radio link. The first network node 603 may be configured to communicate in the wireless communications network 600 with the second network node 605 over a third communication link, e.g., a radio link or a wired link, although communication over more links may be possible.

The UE 601 is enabled to communicate wirelessly within the communications system 600. The communication may be performed, e.g., between two devices, between a device and a regular telephone, between the UE 601 and a network node, between network nodes, and/or between the device and a server via the radio access network and possibly one or more core networks and possibly the internet. It should be noted that the communication links in the communications network may be of any suitable kind including either a wired or wireless link. The link may use any suitable protocol depending on type and level of layer, e.g., as indicated by the Open Systems Interconnection (OSI) model, as understood by the person skilled in the art.

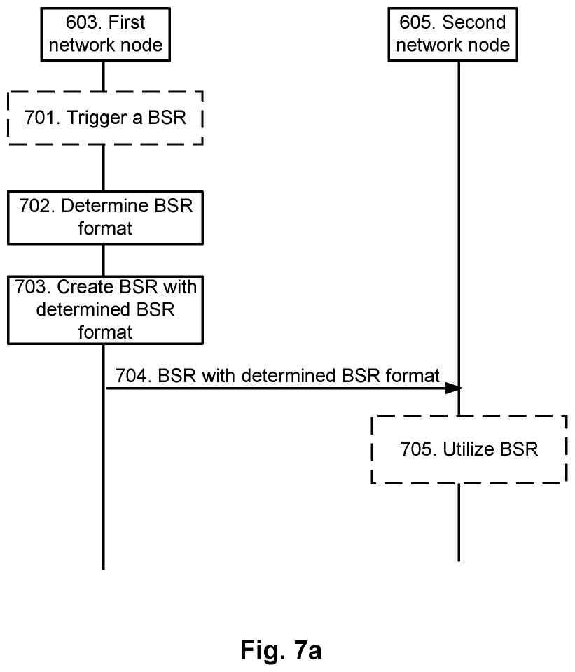

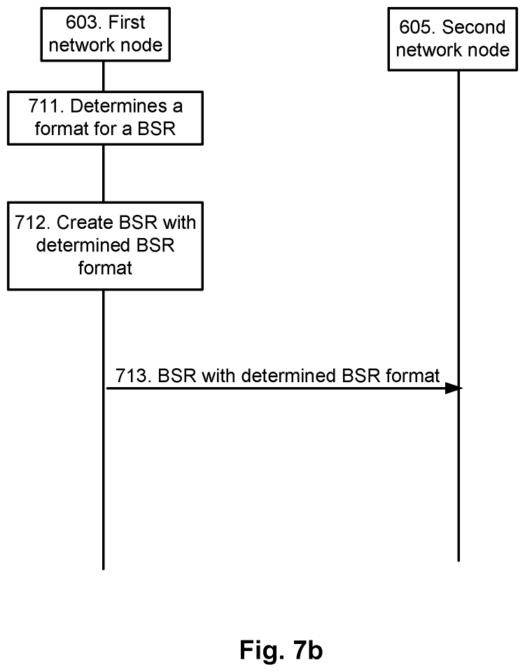

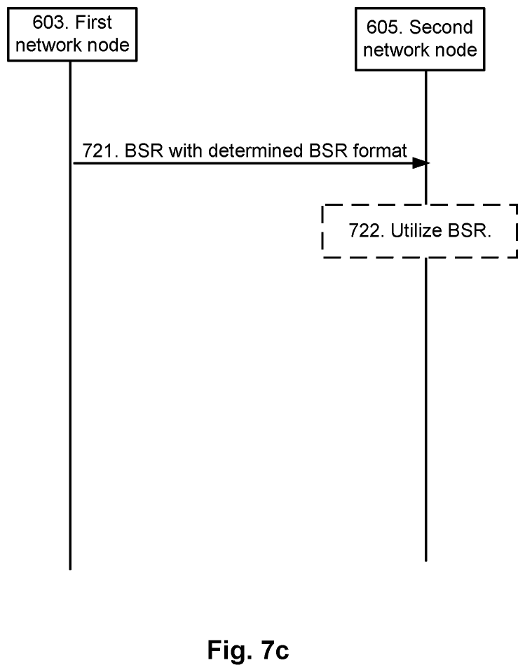

FIG. 7a is a signalling diagram illustrating an example method. The method comprises at least one of the following actions, which actions may be performed in any suitable order than described below:

Action 701. The first network node 603 may trigger a BSR to be created. This may also be described as the first network node 603 determines that a BSR should be created, or detects that a BSR should be created, or receives instructions from some other node in the communications system 600 that a BSR should be created etc.

Action 702. The first network node 603 determines a format, also referred to as a BSR format, for the BSR. A BSR format may be referred to as a setup or layout of the BSR. The BSR format may be determined by the first network node 603 by selecting one of a plurality of candidate BSR formats. The first network node 603 selects the BSR format that the first network node 603 deems is the most efficient format, or the format that is most suitable, or that matches a criterion or in any suitable way.

The format indicates that the BSR comprises at least one of the following:
A total LCG buffer size being the total sum of all LCGs indicated by the LCG range; and/or
An individual LCG buffer size of each LCG in the LCG range and identified with a LCG ID; and/or
A length of Total buffer size field, e.g. number of bytes or bits; and/or
A sum of the buffer size of all LCGs not indicated by any of the LCG range(s) in the BSR; and/or;
A bitmap for each of the LCGs covered in the LCG range, wherein the bitmap indicates, for each of the LCGs, if the buffer size is included or not; and/or
A last segment flag; and/or
A segment number; and/or
A LCG ID; and/or
At least one reserved field; and/or
A number of LCG which are explicitly indicated; and/or
Or any combination of the above.
   The LCG range may be indicated by one or two parameters.
   The LCG range may be indicated by at least one of:
Start LCG identity (ID) and End LCG ID; and/or
Start LCG ID and number of LCGs (n) within the LCG range, for instance LCG ID=4 and number of LCG=3, then the LCG ID for which a BSR is included are LCG ID=4, 5, 6; and/or
Start LCG ID; and/or
LCG set index; and/or
A start LCG parameter and substantially all the LCGs between the start LCG parameter and a next indicated start LCG parameter minus 1.
   The format may be determined by selecting one format from a plurality of candidate formats. The selected format from the plurality of candidate formats is the format which is determined to be the most efficient format by the first network node 603. The format may be selected based on a criterion.

Action 703. The first network node 603 creates the BSR with the determined BSR format from action 702.

Action 704. The first network node 603 provides or forwards the created BSR with the determined BSR format to the second network node 605.

Action 705. The second network node 605 obtains the BSR from the first network node 603. The second network node 605 may utilize the obtained BSR as an input when deciding what grant to assign to the first network node 603 etc.

The first network node 603 may be an IAB node, a MT part of the IAB node, a child node, a gNB, or an eNB. The second network node 605 may be an IAB donor node, a DU 108 associated with or comprised in an IAB donor node, a parent node. The communications system 600 may be a 5G system, a 4G system, a 3G system or a 2G system, or any future system.

The first network node 603 is adapted to:
determine a format for a BSR;
create a BSR with the determined format; and to
provide or forward the BSR with the determined format to a second network node 605.

The format may indicate that the BSR comprises at least one of the following:
A Logical Channel Group, LCG, range; and/or
A total LCG buffer size being the total sum of all LCGs indicated by the LCG range; and/or
An individual LCG buffer size of each LCG in the LCG range and identified with a LCG ID;
A length of Total buffer size field; and/or
A sum of the buffer size of all LCGs not indicated by any of the LCG range(s) in the BSR; and/or;
A bitmap for each of the LCGs covered in the LCG range, wherein the bitmap indicates, for each of the LCGs, if the buffer size is included or not; and/or
A last segment flag; and/or
A segment number; and/or
A LCG ID; and/or
At least one reserved field; and/or
A number of LCG which are explicitly indicated;
Or any combination of the above.
   The LCG range may be indicated by one or two parameters.
   The LCG range may be indicated by at least one of:
Start LCG ID and End LCG ID; and/or
Start LCG ID and number of LCGs (n) within the LCG range; and/or
Start LCG ID; and/or
LCG set index; and/or
A start LCG parameter and substantially all the LCGs between the start LCG parameter and the next indicated start LCG parameter minus 1.

The format may be determined by selecting one format from a plurality of candidate formats. The selected format from the plurality of candidate formats may be the format which is determined to be the most efficient format by the first network node 603. The format may be selected based on a criterion.

The first network node 603 may be an IAB node, a MT part of the IAB node, a child node, a gNB or an eNB. The second network node 605 may be an IAB donor node, a DU 608 associated with or comprised in an IAB donor node, a parent node. The communications system 600 may be a 5G system, a 4G system, a 3G system or a 2G system or any future system.

A computer program may comprise instructions which, when executed on at least one processor, cause the at least one processor to carry out the method according to any one of embodiments herein. A carrier may comprise the computer program, wherein the carrier is one of an electronic signal, optical signal, radio signal or computer readable storage medium.

The method actions performed by the first network node 603 for handling BSRs in the communications system according to embodiments will now be described with reference to a flowchart depicted in FIG. 7b.

Action 711. The first network node 603 determines the format for the BSR, wherein the determined format indicates that the BSR comprises the LCG range. The LCG range may be indicated by one or two parameters. The LCG range may be indicated by at least one of: Start LCG ID and End LCG ID; Start LCG ID; LCG set index; a start LCG parameter and substantially all the LCGs between the start LCG parameter and the next indicated start LCG parameter minus 1. The determined format may indicate that the BSR comprises at least one of the following: a total LCG buffer size being a total sum of all LCGs indicated by the LCG range; an individual LCG buffer size of each LCG in the LCG range and identified with a LCG ID; a length of a total buffer size field; a sum of the buffer size of all LCGs not indicated by any of the LCG range in the BSR; a bitmap for each of the LCGs covered in the LCG range, wherein the bitmap indicates, for each of the LCGs, if the buffer size is included or not; a last segment flag; a segment number; or a LCG ID. The format may be determined by selecting one format from the plurality of candidate formats. The selected format from the plurality of candidate formats may be the format which is determined to be the most efficient format by the first network node 603 by minimizing an overhead of the format. The format may be selected based on a criterion.

Action 712. The first network node 603 creates the BSR with the determined format.

Action 713. The first network node 603 provides the created BSR with the determined format to the second network node 605. The first network node 603 may be an IAB node, an MT part of the IAB node, or a child node. The second network node 605 may be an IAB donor node, a DU associated with or comprised in an IAB donor node, or a parent node.

The method actions performed by the second network node 605 for handling BSRs in the communications system according to embodiments will now be described with reference to a flowchart depicted in FIG. 7c. The actions do not have to be taken in the order stated below but may be taken in any suitable order. Dashed boxes indicate optional features.

Action 721. The second network node 605 obtains the BSR, from the first network node 603, with the determined format, wherein the determined format indicates that the BSR comprises the LCG range. The LCG range may be indicated by one or two parameters. The LCG range may be indicated by at least one of: Start LCG ID and End LCG ID; Start LCG ID; LCG set index; a start LCG parameter and substantially all the LCGs between the start LCG parameter and the next indicated start LCG parameter minus 1.

The determined format may indicate that the BSR comprises at least one of the following: a total LCG buffer size being a total sum of all LCGs indicated by the LCG range; an individual LCG buffer size of each LCG in the LCG range and identified with a LCG ID; a length of a total buffer size field; a sum of the buffer size of all LCGs not indicated by any of the LCG range in the BSR; a bitmap for each of the LCGs covered in the LCG range, wherein the bitmap indicates, for each of the LCGs, if the buffer size is included or not; a last segment flag; a segment number; or a LCG ID.

Action 722. The second network node 605 may utilize the obtained BSR as an input when deciding what grant to assign to the first network node 603.

The first network node 603 may be an IAB node, a MT part of the IAB node, or a child node. The second network node 605 may be an IAB donor node, a DU associated with or comprised in an IAB donor node, or a parent node.

Thus, it is herein provided the second network node 605, see FIG. 6, for handling BSRs in the communications system.

The second network node 605 is adapted to obtain the BSR, from the first network node 603, with a determined format, wherein the determined format indicates that the BSR comprises a LCG range. The LCG range may be indicated by one or two parameters. The LCG range is indicated by at least one of: Start LCG ID and End LCG ID; Start LCG ID; LCG set index; a start LCG parameter and substantially all the LCGs between the start LCG parameter and the next indicated start LCG parameter minus 1. The determined format may indicate that the BSR comprises at least one of the following: a total LCG buffer size being a total sum of all LCGs indicated by the LCG range; an individual LCG buffer size of each LCG in the LCG range and identified with a LCG ID; a length of a total buffer size field; a sum of the buffer size of all LCGs not indicated by any of the LCG range in the BSR; a bitmap for each of the LCGs covered in the LCG range, wherein the bitmap indicates, for each of the LCGs, if the buffer size is included or not; a last segment flag; a segment number; or a LCG ID.

The second network node 605 may be adapted to utilize the obtained BSR as an input when deciding what grant to assign to the first network node 603.

The first network node 603 may be an IAB node, a MT part of the IAB node, or a child node. The second network node 605 may be an IAB donor node, a DU associated with or comprised in an IAB donor node, or a parent node.

Different BSR formats will now be described with potential network configurations in which each of the formats could be useful. A BSR comprises one or more octets.

### Solution 1:

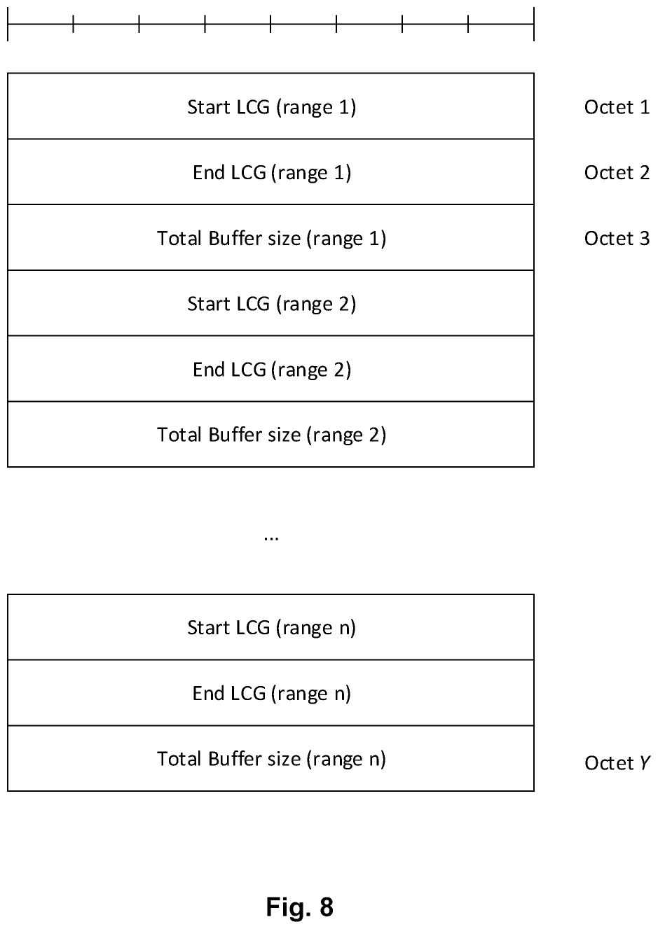

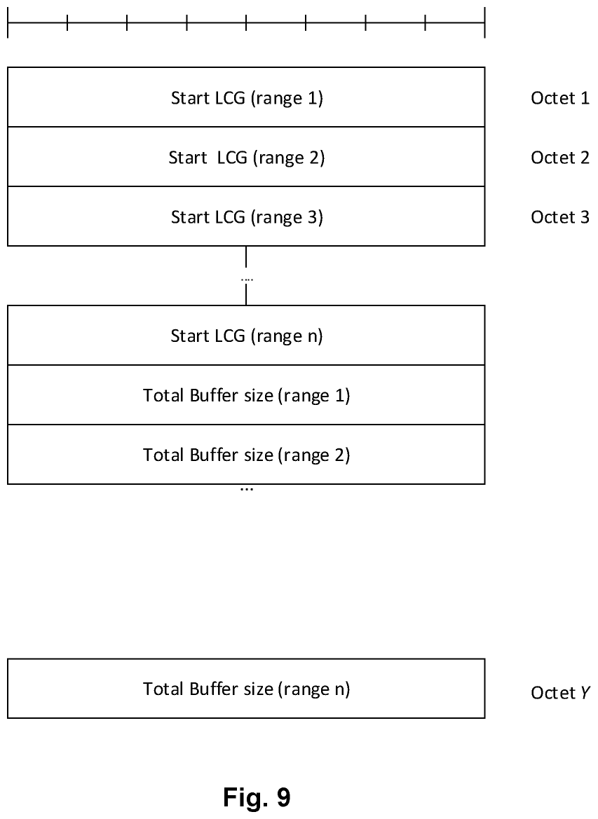

The BSR format is shown in FIG. 8. This format may comprise the following elements:
LCG range: There are various ways to indicate an LCG range
   Option 1: LCG range is indicated by two different fields: Start LCG ID and End LCG ID. This range indicates a set of LCGs which are reported in the BSR.
   Option 2: LCG range is indicated by two different fields: Start LCG ID and number of LCGs (n) within the LCG range. The first field (i.e. LCG ID) signifies the starting LCG for the range and the second field (i.e. n) indicates the number of groups contained in this range.
   Option 3: LCG range is indicated by a single field, i.e. Start LCG ID, while the number of LCGs contain/cover in the LCG range may be preconfigured or derived based on predefined rules.
   Option 4: LCG range is indicated by an LCG set index, wherein the LCGs in the set may be preconfigured via radio resource control (RRC) signalling or derived based on predefined rules.
   Option 5: LCG range is comprised of 1) the start LCG field and 2) all the LCGs between the “start LCG” field and the next indicated “start LCG” field minus 1, as highlighted in FIG. 9. In this case, only the start LCG fields are indicated. For the last indicated start LCG field, the range may comprise from the indicated “start LCG” until the last configured LCG, or otherwise, by some specified RRC rule, an explicit indication by RRC, or indicated in the message too.
   Example: 1st field indicates LCG=0, 2^{nd} field indicates LCG=21. Then, the LCG range 1 contains LCG 0 to 20. LCG range 2 contains LCG 21 to the last configured LCG.
   If this option 5 is used, it may be necessary to include a field with the number of “start LCG” fields which are carried, or a rule is needed which allows identifying the number of “start LCG” fields included in the message, or alternatively, a flag may signify when is the last indicated “start LCG” field.
Total buffer size: This field indicates the sum of the buffer size of each of the logical channel groups indicated in the LCG range.
Length of Total buffer size: This field indicates whether the “Total buffer size” field has a 1 byte or 2-byte length.

These elements may be repeated so a number of different LCG ranges and their associated total buffer size can be reported in the BSR.

This type of solution may be used in a flexible way during network implementations, for example:
Configure a limited number of LCGs per UE 601 so that the LCG range in the BSR is the range of LCGs configured for a UE. This type of solution enables the possibility to allocate an element of BSR, such as LCG range+Total Buffer size fields, to the UE 601 for data reporting, and thus the BSR can be used for a set of UEs.
Another scenario is that the network groups LCID from one or more UEs 601 with the commonality that these LCIDs share similar characteristics such as QoS. This would provide the network information about the amount of data buffered for a specific type of traffic with certain characteristics, e.g., such as EMBB, or other types of traffic.

This can allow the network to differentiate traffic and users and perform better scheduling decisions

Additionally, an extra field similar to the one outlined in solution 5 below could be added to provide the sum of the buffer size of all LCGs not included in this report.

### Solution 2.

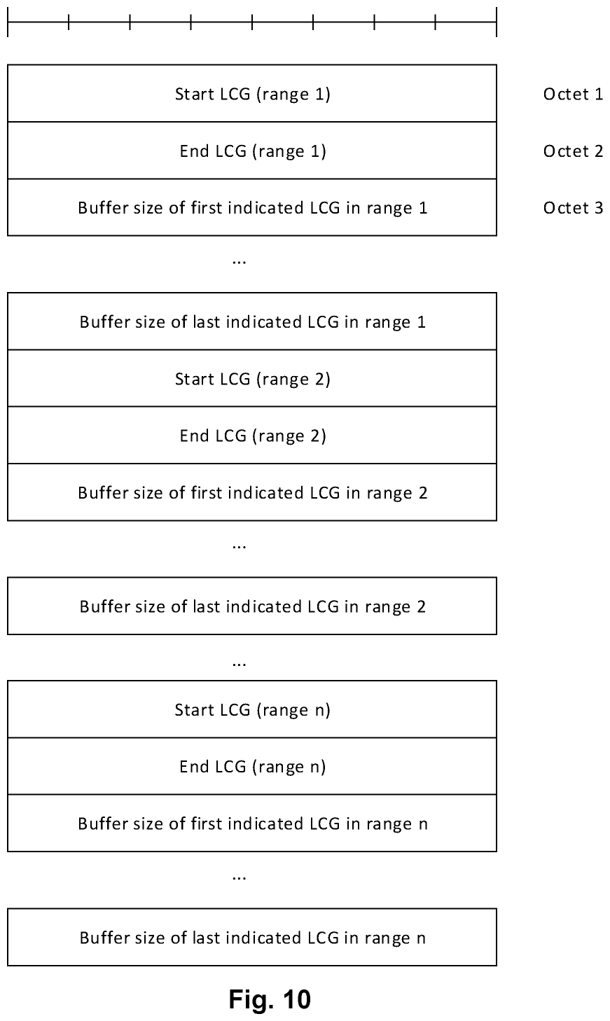

The BSR format is shown in FIG. 10. This BSR format may comprise the following elements:
LCG range: This is compound of two different fields: Start LCG and End LCG. This range indicates a set of LCGs which are reported in the BSR.
LCG buffer size: This field indicates the buffer size of each of the individual logical channel groups indicated in the LCG range.

These elements can be repeated so a number of different LCG ranges and their associated total buffer size can be reported in the BSR.

This type of solution 2 would be useful for network implementations that, for example:
Configure a limited number of LCGs per UE so that the LCG range is the range of LCGs configured for a UE. This type of solution enables the possibility to report the BSR of each of the LCG configured per one UE, or a set of UEs while minimizing the signalling, as there is no need to signal each individual LCG.
Another scenario is that the network groups LCID from one or more UEs with the commonality that these LCIDs share similar characteristics such as QoS. This would provide the network information about the amount of data buffered for a specific type of traffic with certain characteristics, e.g., such as EMBB, or other type of traffic.

This may allow the network to differentiate traffic and users and perform better scheduling decisions. Additionally, an extra field similar as one outlined in solution 5 below could be added to include the sum of the buffer size of all LCGs not included in this BSR report.

### Solution 3.

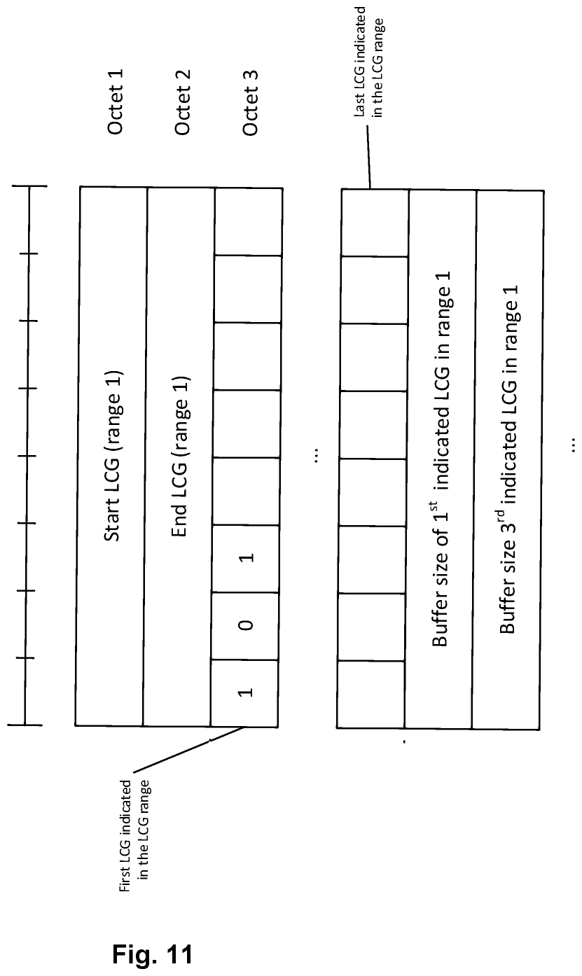

Augmenting Solution 2 with a bitmap for each of the LCGs covered in the range. The bitmap indicates, for each of the LCGs, if the buffer size is included or not. An example is shown in FIG. 11, in which “1” indicates presence of the buffer size, and “0” indicates no presence. Therefore, in this example, the field which would report buffer size of the 2^{nd} LCG indicated in the range is not present.

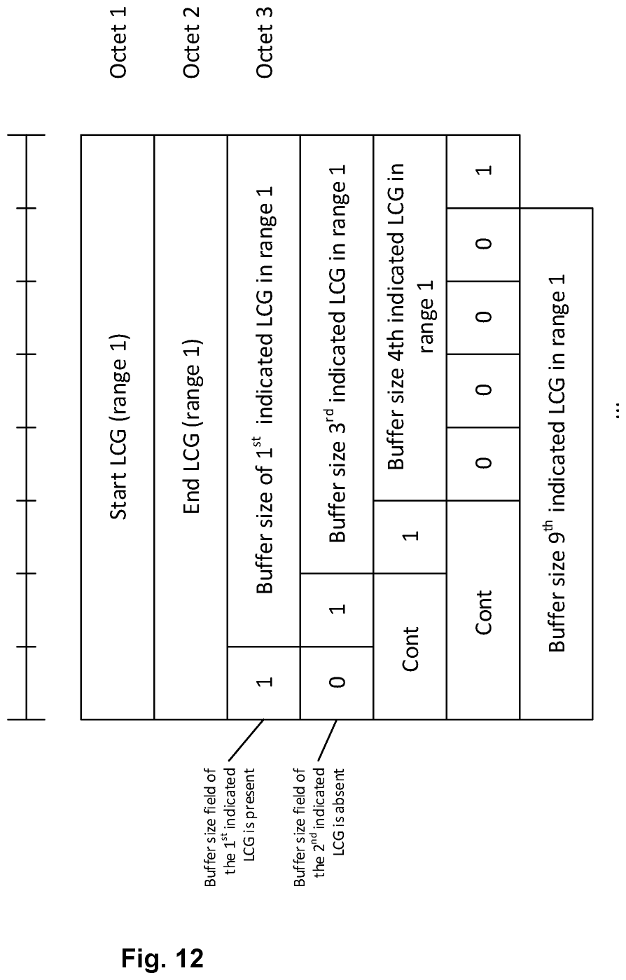

Alternative signalling in which the bits are placed in a different position would be possible; yet, achieving the same purpose. For example, before each buffer size field, one bit would indicate the presence or absence of buffer size field. This is shown in FIG. 12, in which buffer size field of the 2^{nd} LCG indicated in the range is missing as signified by the bit indicating presence or absence. Then, another bit indicating presence/absence of the next buffer size indicated in the LCG range would follow.

This type of format is useful when a number of LCGs in the LCG range do not have any data in the buffer. However, there is a tradeoff. In some cases, it may be more efficient to skip the bitmap and indicate a zero-buffer size, should that be the case. Nevertheless, this is up to the network to decide which is the most efficient format.

Additionally, an extra field similar as the one outlined in the solution 5 below could be added to include the sum of the buffer size of all LCGs not included in this BSR report.

### Solution 4.

Any of the previous solutions plus a segmentation option.

In addition to the fields already defined in the previous solutions, a segmentation field may be included. This is useful when the network wants to limit the resources assigned to the BSR or when there is not enough room for the report containing all fields.

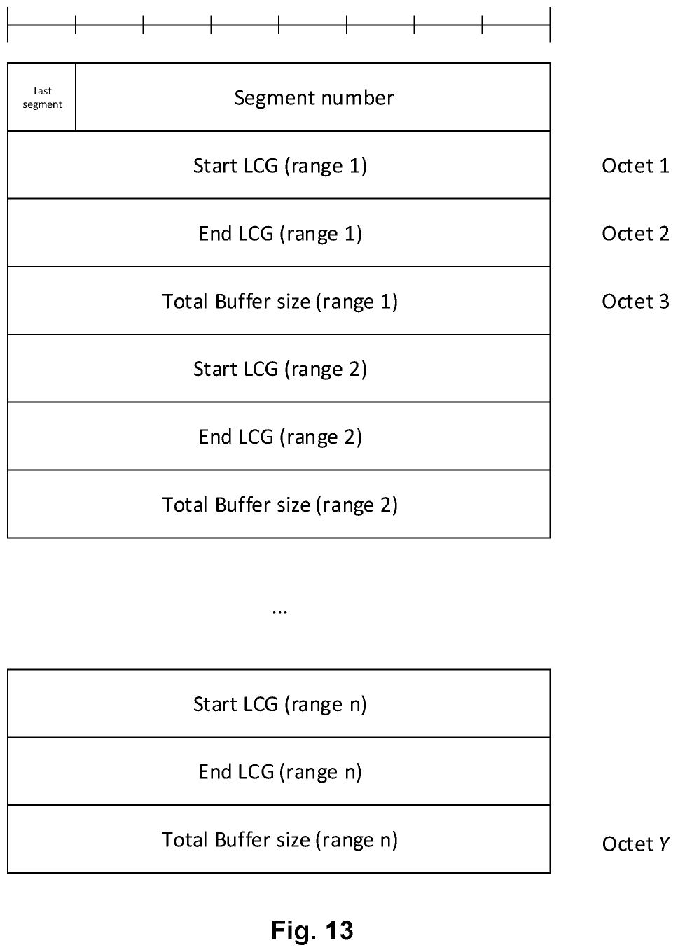

FIG. 13 shows an example in which two additional fields are included:
Last segment flag: indicates if this is the last segment of the segmented BSR. Alternatively, a field could indicate if this is the 1^{st} segment, a last segment, or another middle segment (not first, not last).
Segment number: indicates the segment number among all segments of a segmented BSR.

### Solution 5.

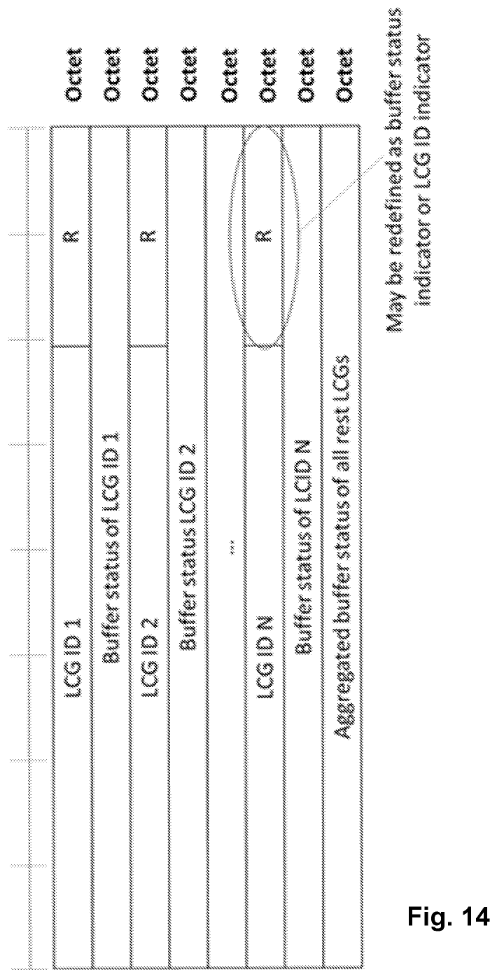

The BSR format is shown in FIG. 14. This format may comprise the following elements:
LCG ID: This comprising of an LCG range, as defined above. This range indicates a range of LCGs which are reported in the BSR.
LCG buffer size: This field indicates the buffer size of the logical channel groups indicated by the LCG ID.
Aggregated buffer status for the rest of LCG: This field indicated the aggregated, i.e., sum of, buffer size of all the logical channel groups not indicated by the LCG ID.

This format comprises respective buffer status indicators for a number of LCGs and an aggregated buffer status report for all the rest LCGs. For each LCG whose buffer status are separately reported, there is an LCG ID field and an associated buffer status value.

In addition, there may be a number of reserved field ‘R’ within which some bits may be redefined as a part of LCG ID field and/or buffer status field when large LCG ID field is needed and/or better buffer status granularity is needed.

The maximum number of LCGs for individual buffer status which should be explicitly reported may be configured using RRC signalling. Alternatively, if the transmitter can dynamically select the LCG ID which is reported, an additional field indicating the number of LCG which are explicitly indicated is included and placed at the beginning of the message.

When the number of LCGs with data to report is greater than the maximum number of LCGs to be accommodated in one buffer status indication, then the total sum of data for the surplus LCGs, i.e., those that cannot be accommodated, is reported in a single field such as aggregated buffer status. This field indicating the total number of buffered bits may be placed in some appropriate position, for instance in the end of the BSR MAC CE. When the number of LCGs with data to report is smaller than the maximum number of LCGs that may be accommodated in one buffer status indication, then the aggregated buffer status field is filled with zero.

In another embodiment, the number of LCGs for individual buffer status indication may be determined by the UE according to the available physical uplink shared channel (PUSCH) capacity for BSR, more LCGs are arranged for individual buffer status report when there are more bytes for BSR report.

In another embodiment, the length of the aggregated buffer status may be longer than a buffer status field to indicate the buffer status for an individual LCG, for good granularity.

In another embodiment, the LCGs for separate buffer status indication have higher priority than, or not lower than, any of the LCGs for aggregated buffer status report, wherein the priority of an LCG depends on the comprised LCH with a highest logical channel priority (LCP).

In another embodiment, when there is not enough capacity to carry the full size BSR MAC CE, it may be preconfigured/predefined to use one or combination of the following two options to truncate the BSR MAC CE:
Option 1: truncate from the end, which means the aggregated buffer status of all the unaccommodated LCGs are discarded first, and if not enough, the individual buffer status report for some LCGs of low priorities are further discarded.
Option 2: reduce the number of LCGs for individual BSR and include more LCGs for aggregated buffer status indication.

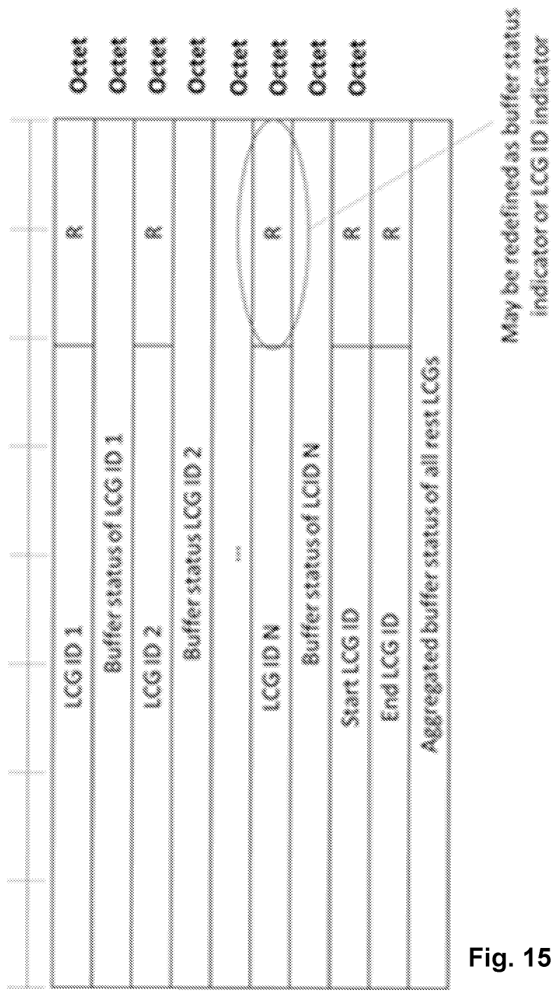

FIG. 14 shows an example of a BSR format according to this embodiment wherein the LCG ID range of all the remaining LCGs with data date to report is not indicated. FIG. 15 shows an example of BSR format according to this embodiment wherein the LCG ID range of all the remaining LCGs with data is indicated using a start LCG ID and an end LCG ID.

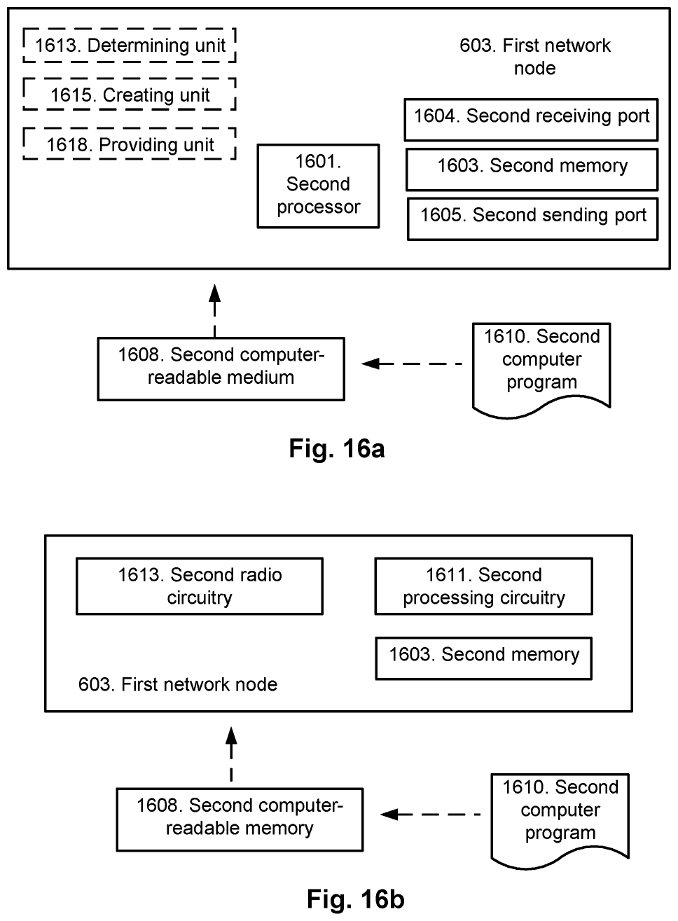

FIG. 16a and FIG. 16b depict two different examples, respectively, of the arrangement that the first network node 603 may comprise. In some embodiments, the network node 605 may comprise the following arrangement depicted in FIG. 16a.

The embodiments herein in the first network node 603 may be implemented through one or more processors, such as a second processor 1601 in the first network node 603 depicted in FIG. 16a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 603. One such carrier may be in the form of a CD ROM disc. It is however feasible with other data carriers such as a memory stick. The computer program code may furthermore be provided as pure program code on a server and downloaded to the first network node 603.

The first network node 603 may further comprise a second memory 1603 comprising one or more memory units. The second memory 1603 is arranged to be used to store obtained information, store data, configurations, scheduling, and applications etc. to perform the methods herein when being executed in the first network node 603. In some embodiments, the first network node 603 may receive information from, e.g., the UE 601 and/or the second network node 605, through a second receiving port 1604. In some embodiments, the second receiving port 1604 may be, for example, connected to one or more antennas in first network node 603. In other embodiments, the first network node 603 may receive information from another structure in the communications system 600 through the second receiving port 1604. Since the second receiving port 1604 may be in communication with the second processor 1601, the second receiving port 1604 may then send the received information to the second processor 1601. The second receiving port 1604 may also be configured to receive other information.

The second processor 1601 in the first network node 603 may be further configured to transmit or send information to e.g., the UE 601 and/or the second network node 605, or another structure in the communications system 100, through a second sending port 1605, which may be in communication with the second processor 1601, and the second memory 1603.

The first network node 603 may comprise a determining unit 1613, a creating unit 1615, a providing unit 1618, etc.

Those skilled in the art will also appreciate that the determining unit 1613, the creating unit 1615, the providing unit 1618 etc. described above may refer to a combination of analogue and digital circuits, and/or one or more processors configured with software and/or firmware, e.g., stored in memory, that, when executed by the one or more processors such as the second processor 1601, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1613-1618 described above may be implemented as one or more applications running on one or more processors such as the second processor 1601.

Thus, the methods according to the embodiments described herein for the first network node 603 may be respectively implemented by means of a second computer program 1610 product, comprising instructions, i.e., software code portions, which, when executed on at least one second processor 1601, cause the at least one second processor 1601 to carry out the actions described herein, as performed by the first network node 603. The second computer program 1610 product may be stored on a second computer-readable storage medium 1608. The computer-readable storage medium 1608, having stored thereon the second computer program 1610, may comprise instructions which, when executed on at least one second processor 1601, cause the at least one second processor 1601 to carry out the actions described herein, as performed by the network node 605. In some embodiments, the computer-readable storage medium 1610 may be a non-transitory computer-readable storage medium, such as a CD ROM disc, or a memory stick. In other embodiments, the second computer program 1610 product may be stored on a carrier containing the second computer program 1610 just described, wherein the carrier is one of an electronic signal, optical signal, radio signal, or the second computer-readable storage medium 1608, as described above.

The first network node 603 may comprise a communication interface configured to facilitate communications between the first network node 603 and other nodes or devices, e.g., the UE 601 and/or the second network node 605, or another structure. The interface may, for example, include a transceiver configured to transmit and receive radio signals over an air interface in accordance with a suitable standard.

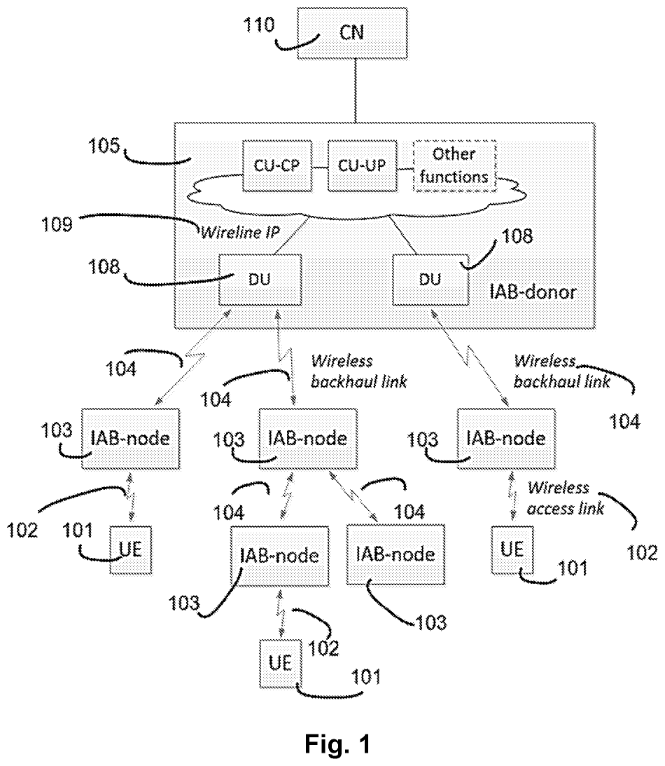

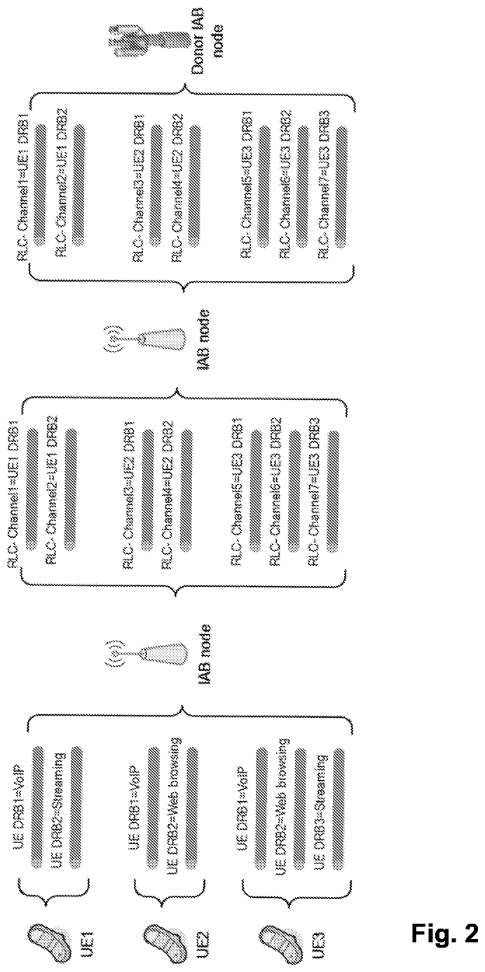

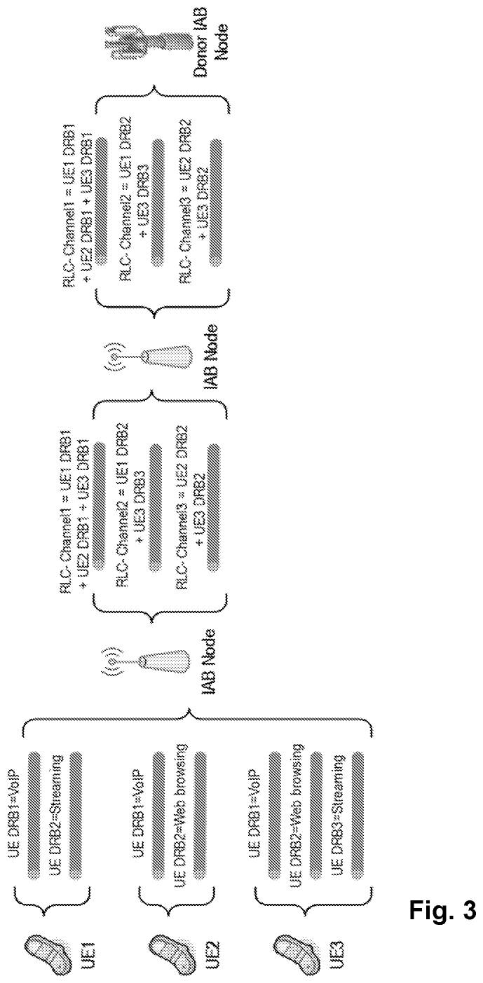

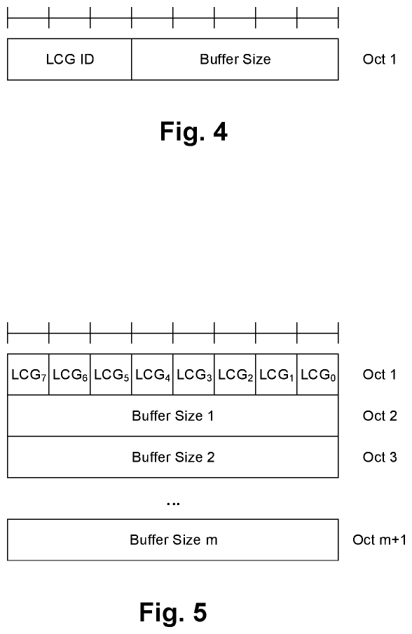

In other embodiments, the first network node 603 may comprise the following arrangement depicted in FIG. 16b. The first network node 603 may comprise a second processing circuitry 1611, e.g., one or more processors such as the second processor 1601, in the first network node 603 and the second memory 1603. The first network node 603 may also comprise a second radio circuitry 1613, which may comprise e.g., the second receiving port 1604 and the second sending port 1605. The second processing circuitry 1611 may be configured to, or operable to, perform the method actions according to FIGS. 1-15 in a similar manner to that described in relation to FIG. 16a. The second radio circuitry 1613 may be configured to set up and maintain at least a wireless connection with the first network node 603. Circuitry may be understood herein as a hardware component.

Hence, embodiments herein also relate to the first network node 603 operative to operate in the communications system 600. The first network node 603 may comprise the second processing circuitry 1613 and the second memory 1603, said second memory 1603 containing instructions executable by said second processing circuitry 1613, whereby the first network node 603 is further operative to perform the actions described herein in relation to the network node 605, e.g., in FIGS. 1-15.

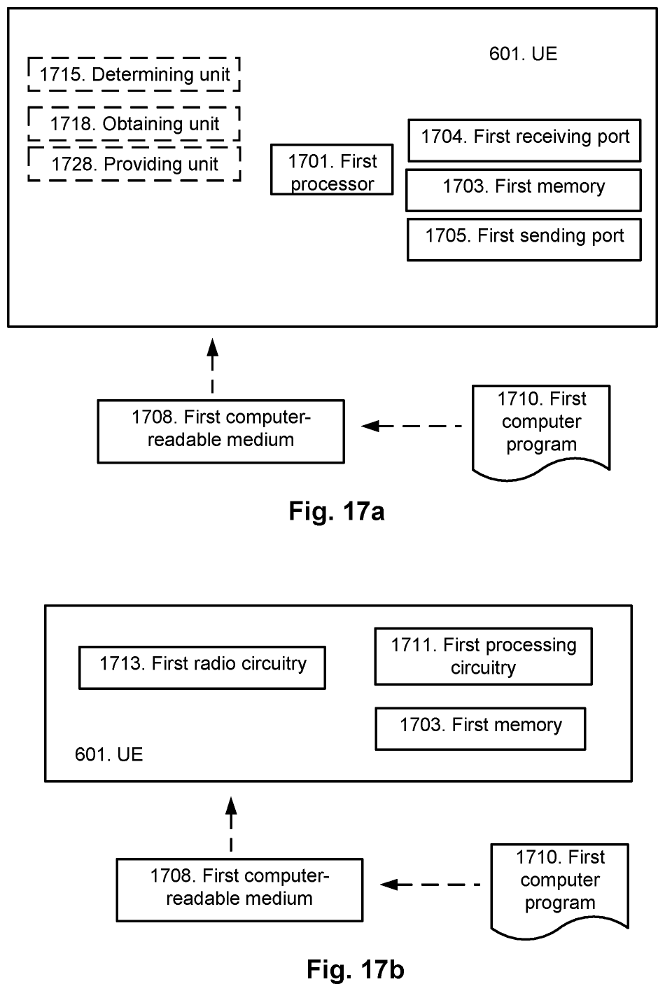

FIG. 17a and FIG. 17b depict two different examples, respectively, of the arrangement that the UE 601 may comprise. In some embodiments, the UE 601 may comprise the following arrangement depicted in FIG. 17a.

The embodiments herein in the UE 601 may be implemented through one or more processors, such as a first processor 1701 in the UE 601 depicted in FIG. 17a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the UE 601. One such carrier may be in the form of a CD ROM disc. It is however feasible with other data carriers such as a memory stick. The computer program code may furthermore be provided as pure program code on a server and downloaded to the UE 601.

The UE 601 may further comprise a first memory 1703 comprising one or more memory units. The memory 1703 is arranged to be used to store obtained information, store data, configurations, schedulings, and applications etc. to perform the methods herein when being executed in the UE 601.

In some embodiments, the UE 601 may receive information from, e.g. the first network node 603 and/or the second network node 605, through a first receiving port 1704. In some embodiments, the first receiving port 1704 may be, for example, connected to one or more antennas in UE 601. In other embodiments, the UE 601 may receive information from another structure in the communications system 600 through the first receiving port 1704. Since the first receiving port 1704 may be in communication with the first processor 1701, the first receiving port 1704 may then send the received information to the first processor 1701. The first receiving port 1704 may also be configured to receive other information.

The first processor 1701 in the UE 601 may be further configured to transmit or send information to, e.g., first network node 603 and/or the second network node 605, or another structure in the communications system 600, through a first sending port 1705, which may be in communication with the first processor 1710, and the first memory 1703.

The UE 601 may comprise a determining unit 1715, an obtaining unit 1718, a providing unit 1728, etc.

Those skilled in the art will also appreciate that the determining unit 1715, obtaining unit 1718, a providing unit 1728 described above may refer to a combination of analogue and digital circuits, and/or one or more processors configured with software and/or firmware, e.g., stored in memory, that, when executed by the one or more processors such as the first processor 1701, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1715-1728 described above may be implemented as one or more applications running on one or more processors such as the first processor 1701.

Thus, the methods according to the embodiments described herein for the UE 601 may be respectively implemented by means of a first computer program 1710 product, comprising instructions, i.e., software code portions, which, when executed on at least one first processor 1701, cause the at least one first processor 1701 to carry out the actions described herein, as performed by the UE 601. The first computer program 1710 product may be stored on a first computer-readable storage medium 1708. The first computer-readable storage medium 609, having stored thereon the first computer program 1710, may comprise instructions which, when executed on at least one first processor 1701, cause the at least one first processor 1701 to carry out the actions described herein, as performed by the UE 601. In some embodiments, the first computer-readable storage medium 1708 may be a non-transitory computer-readable storage medium, such as a CD ROM disc, or a memory stick. In other embodiments, the first computer program 1710 product may be stored on a carrier containing the first computer program 1710 just described, wherein the carrier is one of an electronic signal, optical signal, radio signal, or the first computer-readable storage medium 1708, as described above.

The UE 601 may comprise a communication interface configured to facilitate communications between the UE 601 and other nodes or devices, e.g., the first network node 603 and/or the second network node 605, or another structure. The interface may, for example, include a transceiver configured to transmit and receive radio signals over an air interface in accordance with a suitable standard.

In other embodiments, the UE 601 may comprise the following arrangement depicted in FIG. 17b. The UE 601 may comprise a first processing circuitry 1711, e.g., one or more processors such as the first processor 1710, in the UE 601 and the first memory 1703. The UE 601 may also comprise a first radio circuitry 1713, which may comprise e.g., the first receiving port 1704 and the first sending port 1705. The first processing circuitry 1711 may be configured to, or operable to, perform the method actions according to FIGS. 1-15, in a similar manner as that described in relation to FIG. 17a. The first radio circuitry 1713 may be configured to set up and maintain at least a wireless connection with the UE 601. Circuitry may be understood herein as a hardware component.

Hence, embodiments herein also relate to the UE 601 operative to operate in the communications system 600. The UE 601 may comprise the first processing circuitry 1711 and the first memory 1703, said first memory 1703 containing instructions executable by said first processing circuitry 1711, whereby the UE 601 is further operative to perform the actions described herein in relation to the UE 601, e.g., in FIGS. 1-15.

### FURTHER EXTENSIONS AND VARIATIONS

Telecommunication network connected via an intermediate network to a host computer in accordance with some embodiments.

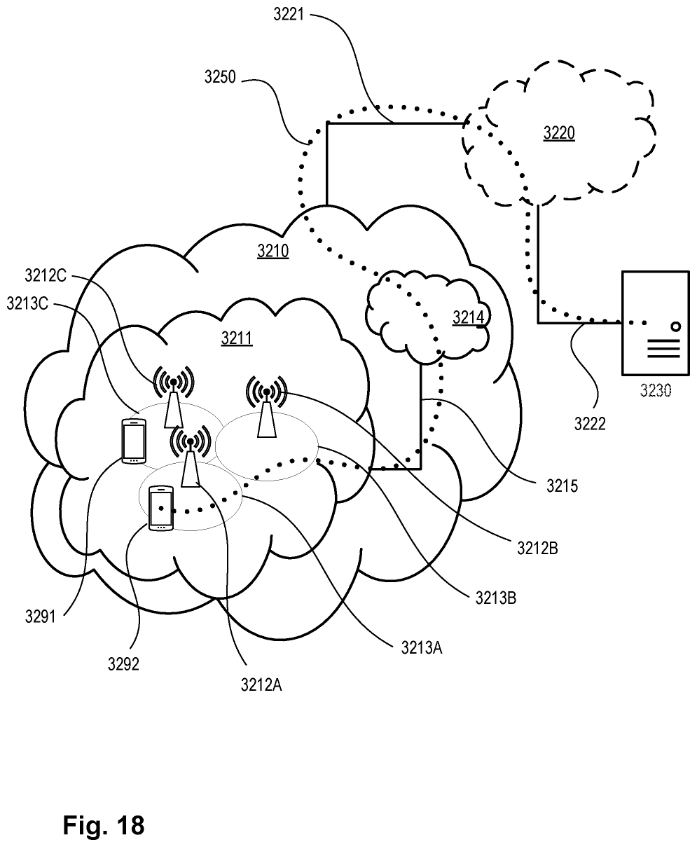

With reference to FIG. 18, in accordance with an embodiment, a communications system includes telecommunication network 3210 such as the communications system 100, for example, a 3GPP-type cellular network, which comprises access network 3211, such as a radio access network, and core network 3214. Access network 3211 comprises a plurality of network nodes 105. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of user equipments, such as the UE 601 may be comprised in the communications system 600. In FIG. 18, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212. Any of the UEs 3291, 3292 may be considered examples of the UE 601.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 18 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signalling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

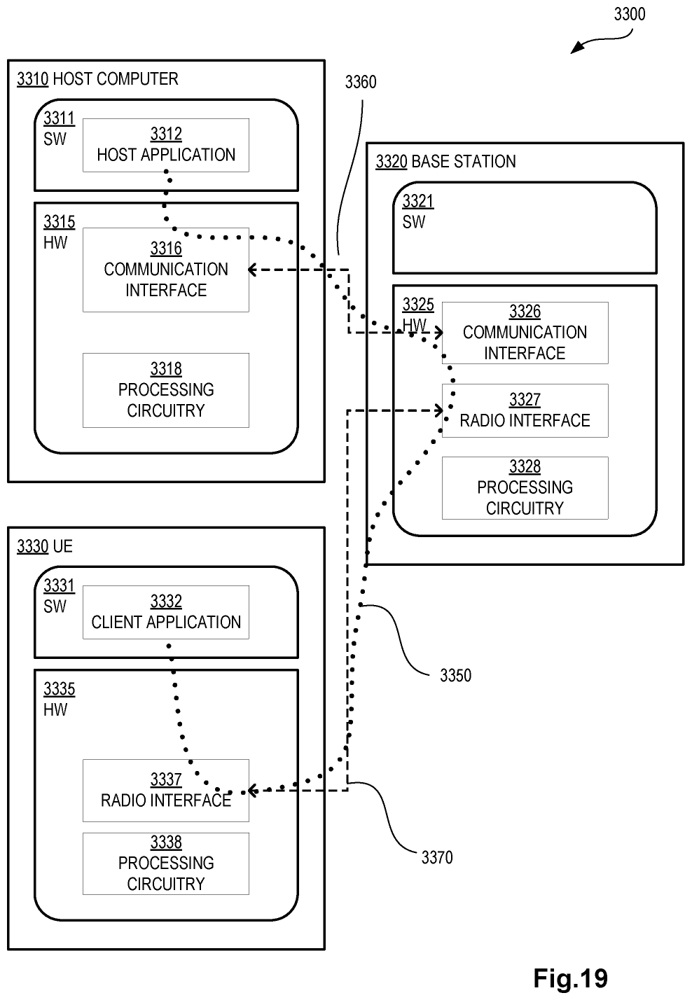

In relation to FIGS. 19-23 which are described next, it may be understood that the base station may be considered an example of the first network node 603.

FIG. 19 illustrates an example of host computer communicating via a first network node 603 with a UE 601 over a partially wireless connection in accordance with some embodiments.

The UE 601 and the first network node 603, e.g., a base station and host computer discussed in the preceding paragraphs will now be described with reference to FIG. 19. In communication system 3330, such as the communications system 600, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes the first network node 603 exemplified in FIG. 19 as a base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with the UE 601, exemplified in FIG. 19 as a UE 3330 located in a coverage area served by base station 3320. Communication interface 3326 may be configured to facilitate connection 3360 to host computer 3310. Connection 3360 may be direct or it may pass through a core network (not shown in FIG. 19) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. It's hardware 3335 may include radio interface 3337 configured to set up and maintain wireless connection 3370 with a base station serving a coverage area in which UE 3330 is currently located. Hardware 3335 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 19 may be similar or identical to host computer 3230, one of base stations 3212a, 3212b, 3212c and one of UEs 3291, 3292 of FIG. 18, respectively. This is to say, the inner workings of these entities may be as shown in FIG. 19 and independently, the surrounding network topology may be that of FIG. 18.

In FIG. 19, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments may improve the spectrum efficiency, and latency, and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signalling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

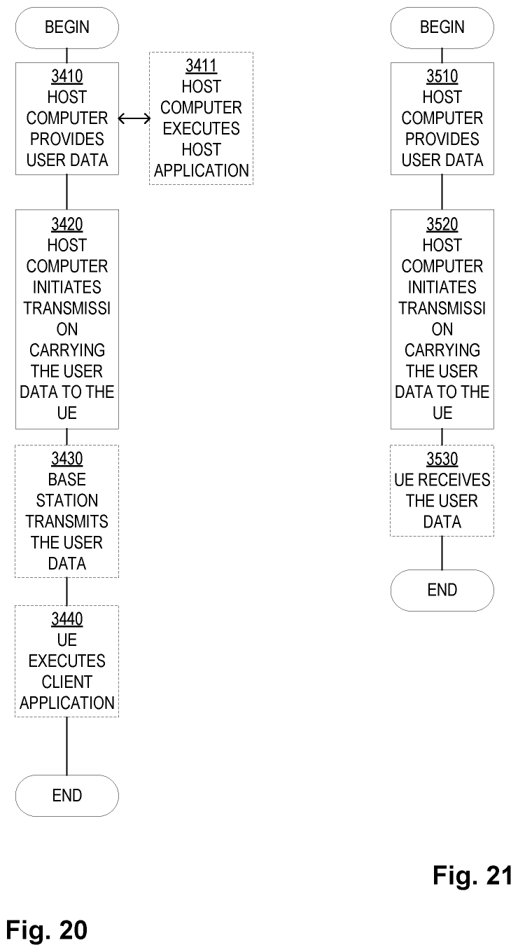

FIG. 20 illustrates an example of methods implemented in a communication system including a host computer, a base station and a user equipment. FIG. 20 is a flowchart illustrating a method implemented in a communication system. The communication system includes a host computer, a base station and a UE which may be those described with reference to FIG. 18 and FIG. 19. For simplicity of the present disclosure, only drawing references to FIG. 20 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 21 illustrates methods implemented in a communication system including a host computer, a base station and a user equipment in accordance with some embodiments. FIG. 21 is a flowchart illustrating a method implemented in a communication system. The communication system includes a host computer, a base station and a UE which may be those described with reference to FIG. 18 and FIG. 19. For simplicity of the present disclosure, only drawing references to FIG. 21 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

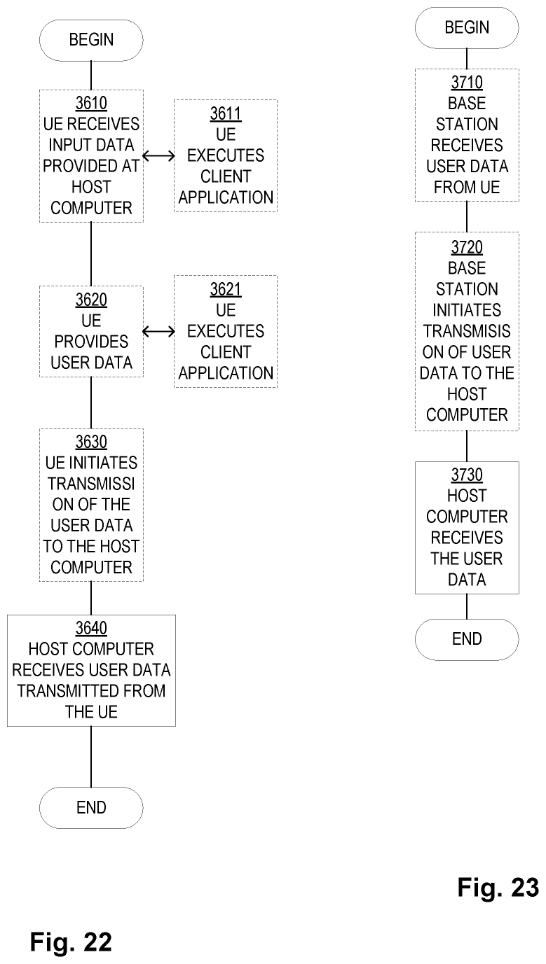

FIG. 22 illustrates methods implemented in a communication system including a host computer, a base station and a user equipment. FIG. 22 is a flowchart illustrating a method implemented in a communication system. The communication system includes a host computer, a first network node 603 and a UE 601 which may be those described with reference to FIG. 18 and FIG. 19. For simplicity of the present disclosure, only drawing references to FIG. 22 will be included in this section. In step 3610 (which may be optional), the UE 601 receives input data provided by the host computer. Additionally or alternatively, in step 3620, the UE 601 provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 23 illustrates methods implemented in a communication system including a host computer, a base station and a user equipment. FIG. 23 is a flowchart illustrating a method implemented in a communication system. The communication system includes a host computer, a base station and a UE which may be those described with reference to FIG. 18 and FIG. 19. For simplicity of the present disclosure, only drawing references to FIG. 23 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Some embodiments may be summarized as follows:

A base station configured to communicate with a UE 601, the base station comprising a radio interface and processing circuitry configured to perform one or more of the actions described herein as performed by the first network node 603.

A communications system 600 including a host computer comprising:
processing circuitry configured to provide user data; and
communication interface configured to forward the user data to a cellular network for transmission to a UE 601,
wherein the cellular network comprises a first network node 603 having a radio interface and processing circuitry, the base station's processing circuitry configured to perform one or more of the actions described herein as performed by the network node 603.

The communications system may further include the first network node 603.

The communications system may further include the UE 601, wherein the UE 601 is configured to communicate with the first network node 603.

The communications system, wherein:
the processing circuitry of the host computer is configured to execute a host application, thereby providing the user data; and
the UE 601 comprises processing circuitry configured to execute a client application associated with the host application.

A method implemented in a first network node 603, comprising one or more of the actions described herein as performed by the first network node 603.

A method implemented in a communications system 600 including a host computer, a base station and a UE 601, the method comprising:
at the host computer, providing user data; and
at the host computer, initiating a transmission carrying the user data to the UE 601 via a cellular network comprising the first network node 603, wherein the first network node 603 performs one or more of the actions described herein as performed by the first network node 603.

The method may further comprise:
at the first network node 603, transmitting the user data.

The user data may be provided at the host computer by executing a host application, and the method may further comprise:
at the UE 601, executing a client application associated with the host application.

A UE 601 configured to communicate with a first network node 603, the UE 601 comprising a radio interface and processing circuitry configured to perform one or more of the actions described herein as performed by the UE 601.

A communications system 600 including a host computer comprising:
processing circuitry configured to provide user data; and
a communication interface configured to forward user data to a cellular network for transmission to a UE 601,
wherein the UE comprises a radio interface and processing circuitry, the UE's processing circuitry configured to perform one or more of the actions described herein as performed by the UE 601.

The communications system may further include the UE 601.

The communications system 600, wherein the cellular network further includes a first network node 603 configured to communicate with the UE 601.

The communications system 600, wherein:
the processing circuitry of the host computer is configured to execute a host application, thereby providing the user data; and
the UE's processing circuitry is configured to execute a client application associated with the host application.

A method implemented in a UE 601, comprising one or more of the actions described herein as performed by the UE 601.

A method implemented in a communications system 600 including a host computer, a first network node 603 and a UE 601, the method comprising:
at the host computer, providing user data; and
at the host computer, initiating a transmission carrying the user data to the UE 601 via a cellular network comprising the base station, wherein the UE 601 performs one or more of the actions described herein as performed by the UE 601.

The method may further comprise:
at the UE 601, receiving the user data from the first network node 603.

A UE 601 configured to communicate with a first network node 603, the UE 601 comprising a radio interface and processing circuitry configured to perform one or more of the actions described herein as performed by the UE 601.

A communications system 600 including a host computer comprising:
a communication interface configured to receive user data originating from a transmission from a UE 601 to a first network node 603,
wherein the UE 601 comprises a radio interface and processing circuitry, the UE's processing circuitry configured to: perform one or more of the actions described herein as performed by the UE 601.

The communications system 600 may further include the UE 601.

The communications system 600 may further include the first network node 603, wherein the first network node 603 comprises a radio interface configured to communicate with the UE 601 and a communication interface configured to forward to the host computer the user data carried by a transmission from the UE 601 to the base station.

The communications system 600, wherein:
the processing circuitry of the host computer is configured to execute a host application; and
the UE's processing circuitry is configured to execute a client application associated with the host application, thereby providing the user data.

The communications system 600, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 601, comprising one or more of the actions described herein as performed by the UE 601.

The method may further comprise:
providing user data; and
forwarding the user data to a host computer via the transmission to the first network node 603.

A method implemented in a communications system 600 including a host computer, a first network node 603 and a UE 601, the method comprising:
at the host computer, receiving user data transmitted to the first network node 603 from the UE 601, wherein the UE 601 performs one or more of the actions described herein as performed by the UE 601.

The method may further comprise:
at the UE 601, providing the user data to the first network node 603.

The method may further comprise:
at the UE 601, executing a client application, thereby providing the user data to be transmitted; and
at the host computer, executing a host application associated with the client application.

The method may further comprise:
at the UE 601, executing a client application; and
at the UE 601, receiving input data to the client application, the input data being provided at the host computer by executing a host application associated with the client application,
wherein the user data to be transmitted is provided by the client application in response to the input data.

A first network node 603 configured to communicate with a UE 601, the first network node 603 comprising a radio interface and processing circuitry configured to perform one or more of the actions described herein as performed by the network node 603.

A communications system 600 including a host computer comprising a communication interface configured to receive user data originating from a transmission from a UE 601 to a base station, wherein the first network node 603 comprises a radio interface and processing circuitry, the base station's processing circuitry configured to perform one or more of the actions described herein as performed by the first network node 603.

The communications system 600 may further include the first network node 603.

The communications system 600 may further include the UE 601, wherein the UE 601 is configured to communicate with the first network node 603.

The communications system 600 wherein:
the processing circuitry of the host computer is configured to execute a host application;
the UE 601 is configured to execute a client application associated with the host application, thereby providing the user data to be received by the host computer.

A method implemented in a first network node 603, comprising one or more of the actions described herein as performed by any of the first network node 603.

A method implemented in a communications system including a host computer, a first network node 603 and a UE 601, the method comprising:
at the host computer, receiving, from the first network node 603, user data originating from a transmission which the base station has received from the UE 601, wherein the UE 601 performs one or more of the actions described herein as performed by the UE 601.

The method may further comprise:
at the first network node 603, receiving the user data from the UE 601.

The method may further comprise:
at the first network node 603, initiating a transmission of the received user data to the host computer.

The embodiments herein relate to signalling for BSR reporting. This the embodiments herein aim to be efficient by minimizing the overhead. The embodiments herein relate to a BSR format for IAB nodes.

The embodiments herein relate to BSR formats enabling an efficient buffer status report even when there are many LCGs configured in an uplink backhaul link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments

The embodiments herein are not limited to the above described embodiments. Various alternatives, modifications and equivalents may be used. Therefore, the above embodiments should not be taken as limiting the scope of the embodiments. A feature from one embodiment may be combined with one or more features of any other embodiment.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

It should also be emphasised that the steps of the methods may, without departing from the embodiments herein, be performed in another order than the order in which they appear herein.

### SOME EMBODIMENTS

1. A method performed by a first network node (603) for handling Buffer Status Reports, BSR in a communications system (600), the method comprising
determining (702) a format for a BSR;
creating (703) a BSR with the determined format; and
providing or forwarding (704) the BSR with the determined format to a second network node (605).
2. The method according to any of the preceding embodiments, wherein the format indicates that the BSR comprises at least one of the following:
A Logical Channel Group, LCG, range;
A total LCG buffer size being the total sum of all LCGs indicated by the LCG range;
An individual LCG buffer size of each LCG in the LCG range and identified with a LCG ID;
A length of Total buffer size field;
A sum of the buffer size of all LCGs not indicated by any of the LCG range(s) in the BSR;
A bitmap for each of the LCGs covered in the LCG range, wherein the bitmap indicates, for each of the LCGs, if the buffer size is included or not; and/or
A last segment flag;
A segment number;
A LCG ID; and/or
Or any combination of the above.
3. The method according to any of the preceding embodiments, wherein the LCG range is indicated by one or two parameters.
4. The method according to any of any of the preceding embodiments, wherein the LCG range is indicated by at least one of:
Start LCG ID and End LCG ID; and/or
Start LCG ID; and/or
LCG set index; and/or
A start LCG parameter and substantially all the LCGs between the start LCG parameter and the next indicated start LCG parameter minus 1.
5. The method according to any of the preceding embodiments, wherein the format is determined by selecting one format from a plurality of candidate formats.
6. The method according to any of the preceding embodiments, wherein the selected format from the plurality of candidate formats is the format which is determined to be the most efficient format by the first network node (603).
7. The method according to any of the preceding embodiments, wherein the format is selected based on a criterion.
8. The method according to any of the preceding embodiments, wherein the first network node (603) is an Integrated Access Backhaul, IAB, node, a Mobile Termination, MT, part of the IAB node, a child node, a gNB or an eNB.
9. The method according to any of the preceding embodiments, wherein the second network node (605) is an Integrated Access Backhaul, IAB, donor node, a Distributed Unit, DU, (108) associated with or comprised in an IAB donor node, a parent node.
10. The method according to any of the preceding embodiments, wherein the communications system (600) is a 5G system, a 4G system, a 3G system or a 2G system or any future system.
11. A first network node (603) adapted to:
determine a format for a Buffer Status Reports, BSR;
create a BSR with the determined format; and to
provide or forward the BSR with the determined format to a second network node (605).
12. The first network node (603) according to any of the preceding embodiments, wherein the format indicates that the BSR comprises at least one of the following:
A Logical Channel Group, LCG, range; and/or
A total LCG buffer size being the total sum of all LCGs indicated by the LCG range; and/or
An individual LCG buffer size of each LCG in the LCG range and identified with a LCG ID.
A length of Total buffer size field; and/or
A sum of the buffer size of all LCGs not indicated by any of the LCG range(s) in the BSR; and/or;
A bitmap for each of the LCGs covered in the LCG range, wherein the bitmap indicates, for each of the LCGs, if the buffer size is included or not; and/or
A last segment flag; and/or
A segment number; and/or
A LCG ID; and/or
Or any combination of the above.
13. The first network node (603) according to any of the preceding embodiments, wherein the LCG range is indicated by one or two parameters.

14. The first network node (603) according to any of any of the preceding embodiments, wherein the LCG range is indicated by at least one of:
Start LCG ID and End LCG ID; and/or
Start LCG ID; and/or
LCG set index; and/or
A start LCG parameter and substantially all the LCGs between the start LCG parameter and the next indicated start LCG parameter minus 1.
15. The first network node (603) according to any of the preceding embodiments, wherein the format is determined by selecting one format from a plurality of candidate formats.
16. The first network node (603) according to any of the preceding embodiments, wherein the selected format from the plurality of candidate formats is the format which is determined to be the most efficient format by the first network node (603).
17. The first network node (603) according to any of the preceding embodiments, wherein the format is selected based on a criterion.
18. The first network node (603) according to any of the preceding embodiments, wherein the first network node (603) is an Integrated Access Backhaul, IAB, node, a Mobile Termination, MT, part of the IAB node, a child node, a gNB or an eNB.
19. The first network node (603) according to any of the preceding embodiments, wherein the second network node (605) is an Integrated Access Backhaul, IAB, donor node, a Distributed Unit, DU, (108) associated with or comprised in an IAB donor node, a parent node.
20. The first network node (603) according to any of the preceding embodiments, wherein the communications system (600) is a 5G system, a 4G system, a 3G system or a 2G system or any future system.
21. A computer program comprising instructions which, when executed on at least one processor, cause the at least one processor to carry out the method according to any one of embodiments 1-10.
22. A carrier comprising the computer program of embodiment 21, wherein the carrier is one of an electronic signal, optical signal, radio signal or computer readable storage medium.

1. A method performed by a first network node for handling Buffer Status Reports (BSR) in a communications system, the method comprising:
determining a format for a BSR, wherein the determined format indicates that the BSR comprises a Logical Channel Group (LCG) range;
creating the BSR with the determined format; and
providing the created BSR with the determined format to a second network node.

2. The method according to claim 1, wherein the determined format indicates that the BSR comprises at least one of the following:
a total LCG buffer size being a total sum of all LCGs indicated by the LCG range;
an individual LCG buffer size of each LCG in the LCG range and identified with a LCG identity (ID);
a length of a total buffer size field;
a sum of the buffer size of all LCGs not indicated by any of the LCG range in the BSR;
a bitmap for each of the LCGs covered in the LCG range, wherein the bitmap indicates, for each of the LCGs, if the buffer size is included or not;
a last segment flag;
a segment number; or
a LCG ID.

3. The method according to claim 1, wherein the LCG range is indicated by one or two parameters.

4. The method according to claim 1, wherein the LCG range is indicated by at least one of:
Start LCG ID and End LCG ID;
Start LCG ID;
LCG set index; or
A start LCG parameter and substantially all the LCGs between the start LCG parameter and a next indicated start LCG parameter minus 1.

5. The method according to claim 1, wherein the format is determined by selecting one format from a plurality of candidate formats.

6. The method according to claim 5, wherein the selected format from the plurality of candidate formats is the format which is determined to be the most efficient format by the first network node by minimizing an overhead of the format.

7. The method according to claim 5, wherein the format is selected based on a criterion.

8. The method according to claim 1, wherein the first network node is an Integrated Access Backhaul (IAB) node, a Mobile Termination (MT) part of the IAB node, or a child node.

9. The method according to claim 1, wherein the second network node is an Integrated Access Backhaul (IAB) donor node, a Distributed Unit (DU) associated with or comprised in an IAB donor node, or a parent node.

10. A first network node adapted to:
determine a format for a Buffer Status Reports (BSR), wherein the determined format indicates that the BSR comprises a Logical Channel Group (LCG) range;
create the BSR with the determined format; and to
provide or forward the created BSR with the determined format to a second network node.

11-18. (canceled)

19. A method performed by a second network node for handling Buffer Status Reports (BSR) in a communications system, the method comprising:
obtaining a BSR, from a first network node, with a determined format, wherein the determined format indicates that the BSR comprises a Logical Channel Group (LCG) range.

20. The method according to claim 19, wherein the determined format indicates that the BSR comprises at least one of the following:
a total LCG buffer size being a total sum of all LCGs indicated by the LCG range;
an individual LCG buffer size of each LCG in the LCG range and identified with a LCG identity (ID);
a length of a total buffer size field;
a sum of the buffer size of all LCGs not indicated by any of the LCG range in the BSR;
a bitmap for each of the LCGs covered in the LCG range, wherein the bitmap indicates, for each of the LCGs, if the buffer size is included or not;
a last segment flag;
a segment number; or
a LCG ID.

21. The method according to claim 19, wherein the LCG range is indicated by one or two parameters.

22. The method according to claim 19, wherein the LCG range is indicated by at least one of:
Start LCG ID and End LCG ID;
Start LCG ID;
LCG set index; or
A start LCG parameter and substantially all the LCGs between the start LCG parameter and a next indicated start LCG parameter minus 1.

23. The method according to claim 19, further comprising:
utilizing the obtained BSR as an input when deciding what grant to assign to the first network node.

24. The method according to claim 19, wherein the first network node is an Integrated Access Backhaul (IAB) node, a Mobile Termination (MT) part of the IAB node, or a child node.

25. The method according to claim 19, wherein the second network node is an Integrated Access Backhaul (IAB) donor node, a Distributed Unit (DU) associated with or comprised in an IAB donor node, or a parent node.

26. A non-transitory computer readable storage medium comprising instructions which, when executed on at least one processor, cause the at least one processor to carry out the method according to claim 1.

27-34. (canceled)

35. A non-transitory computer readable storage medium comprising instructions which, when executed on at least one processor, cause the at least one processor to carry out the method according to claim 19.
